(19) United States
(12) Patent Application Publication
(10) Pub. No.: US 2012/0198501 A1
(43) Pub. Date: Aug. 2, 2012

(54) Method and device for hierarchical transmission and reception in mobile multimedia broadcasting system

(75) Inventors: Yaping Ruan, Shenzhen (CN); Jianqiang Zhang, Shenzhen (CN); Dengjin Tong, Shenzhen (CN)

(73) Assignee: ZTE CORPORATION, Shenzhen, Guangdong (CN)

(21) Appl. No.: 13/381,908

(22) PCT Filed: May 19, 2010
(86) PCT No.: PCT/CN10/72958

§ 371 Date: Mar. 6, 2012

(30) Foreign Application Priority Data
Jul. 7, 2009 (CN) 200910088679.3

(51) Int. Cl. H04N 7/16

(52) U.S. Cl. 725/62

(57) ABSTRACT

The disclosure discloses a method for hierarchical transmission in a mobile multimedia broadcasting system, including: dividing a video stream in a video service into a basic layer code stream and at least one enhanced layer code stream; encapsulating them in different multiplexing subframes of a broadcasting channel frame according to respective layers to which they belong; and sending the location information of the multiplexing subframes to a receiving terminal. The disclosure further discloses a method for hierarchical reception in a mobile multimedia broadcasting system, including: monitoring, by the receiving terminal, the location information of the multiplexing subframes of a broadcasting channel frame, code streams of a plurality of layers of a video stream of a video service being encapsulated in said multiplexing subframes, receiving only the basic layer code stream or both the basic layer code stream and the corresponding enhanced layer code stream, decoding only the basic layer code stream or both the basic layer code stream and the corresponding enhanced layer code stream, and outputting the video data of the basic layer code stream or that generated by combining the basic layer code stream with the corresponding enhanced layer code stream. The disclosure further discloses a device implementing the methods above. The disclosure is simple to implement and is practical.

### TECHNICAL FIELD

The disclosure relates to transmission technologies in mobile multimedia broadcasting systems and, more particularly, to methods and devices for hierarchical transmission and reception of video streams in a China Mobile Multimedia Broadcasting (CMMB) system.

### BACKGROUND

With the development of technology, multimedia broadcasting technology, particularly mobile multimedia broadcasting technology is developed fast. Now, widely accepted standards for mobile multimedia broadcasting technology include: Digital Video Broadcast-Handhold (DVB-H), Terrestrial Digital Multimedia Broadcasting (T-DMB), CMMB and the like.

DVB-H adopts technology of constructing networks based on hierarchical modulation to allow two independent multiplexing layers in a system to share a same channel. It has been proposed that a same video content should be transmitted in two different code rates through hierarchical modulation so as to be selected and used adaptively by terminals with different capabilities and reception environments to maximize the quality of user experience. Such method, however, has the defect of having a redundancy between two multiplexing contents, which may bring about a huge waste of channel width.

Thereafter, someone makes an improvement on the basis of the abovementioned method, a video hierarchical coding way rather than the hierarchical modulation is adopted to transmit the information of two layers of the same video content, a basic layer code stream can be decoded separately and an enhanced layer code stream contains additional information used for improving the quality of the basic layer code stream. A video hierarchical coder can code video content sources to generate L+1 layer code streams. The L+1 layer code streams include a basic layer code stream which can be separately decoded and also include L enhanced layer code streams which contain additional information used for improving the quality of the basic layer code stream and need to be decoded with the basic layer code stream to improve the video quality. The code streams of all layers will be converged to provide the highest video quality. At present, the major video hierarchical coding way is the Scalable Video Coding (SVC).

The CMMB standard stipulates the frame structure, and channel coding and modulation ways of a broadcasting channel transmission signal of the mobile multimedia broadcasting system in the frequency range of the broadcasting service. The CMMB standard, Second Part of Mobile Multimedia Broadcasting: Multiplexing, stipulates that a multiplexing subframe is adopted to encapsulate the transmission of video, audio and other streaming media data. FIG. 1 is a diagram showing the composition structure of a CMMB channel frame, as shown in FIG. 1, a CMMB channel frame is divided into 40 time slots each being 25 ms; a multiplexing frame can casually occupy one or more time slots and is identified by a multiplexing frame identifier MF_ID which represents a control channel multiplexing frame when being 0 and an ordinary multiplexing frame when not being 0. A time slot 0 transmits the control information of a multiplexing frame, i.e., a control information multiplexing frame, which consists of a frame header and a control information table. A multiplexing frame consists of a multiplexing frame header, a multiplexing frame payload and a filler; and various service data is born in the multiplexing payload. The multiplexing frame payload is further divided into multiple multiplexing subframes each being used for transmitting a service. Each multiplexing subframe consists of a multiplexing subframe header and a load which consists of segments; and the segments include audio segments, video segments and data segments, which respectively bear video data, audio data and other data of a service.

However, the CMMB system does not support hierarchical modulation, and, there are still no related solutions for supporting a hierarchical coding video service in the CMMB system now.

### SUMMARY

For the reasons above, the main objective of the disclosure is to provide methods and devices for hierarchical transmission and reception of in a mobile multimedia broadcasting system, which can hierarchically transmit a video service in a CMMB system so as to meet the multilevel service requirements of a user terminal.

In order to achieve the objective, the technical solution of the disclosure is implemented as follows:

A method for hierarchical transmission in a mobile multimedia broadcasting system, includes the step of that:

the video stream of the video service is sequentially divided into a basic layer code stream and at least one enhanced layer code stream; the basic layer code stream and the at least one enhanced layer code stream are encapsulated in different multiplexing subframes of a broadcasting channel frame according to respective layers to which they belong; and location information of the multiplexing subframes are encapsulated in the broadcasting channel frame and the broadcasting channel frame is sent to a receiving terminal.

Preferably, the multiplexing subframes have an interval of time with a predetermined threshold.

Preferably, the multiplexing subframes belong to different multiplexing frames.

Preferably, the multiplexing subframes have a same subframe number.

Preferably, the audio stream and data stream of the video service are born in the multiplexing subframe in which the basic layer code stream is encapsulated.

A method for hierarchical reception in a mobile multimedia broadcasting system, includes:

the location information of the multiplexing subframes of the broadcasting channel frame is monitored, code streams of a plurality of layers of a video stream of a video service being encapsulated in said multiplexing subframes; and the receiving terminal receives only basic layer code stream of the video stream or both basic layer code and corresponding enhanced layer code stream of the video stream, according to video stream processing capability of the receiving terminal, decodes only the basic layer code stream or both the basic layer code stream and the corresponding enhanced layer code stream, and outputs the video data of the basic layer code stream or that of the combined basic layer code stream and enhanced layer code stream.

Preferably, the method further includes the step of that:

decoding audio stream and other basic data streams of the video service, while decoding the basic layer code stream.

A device for hierarchical transmission in a mobile multimedia broadcasting system, includes:

a dividing unit configured to divide a video stream of a video service into a basic layer code stream and at least one enhanced layer code stream;

a first encapsulating unit configured to encapsulate, in different multiplexing subframes of a broadcasting channel frame, the basic layer code stream and the at least one enhanced layer code stream according to respective layers to which they belong;

a location information generating unit configured to generate location information of said multiplexing subframes;

a second encapsulating unit configured to encapsulate, in the broadcasting channel frame, the location information of said multiplexing subrframes; and

a transmitting unit configured to transmit the broadcasting channel frame to a receiving terminal.

Preferably, the multiplexing subframes may have an interval of time with a predetermined threshold.

Preferably, the multiplexing subframes may belong to different multiplexing frames.

Preferably, the multiplexing subframes may have the same subframe number.

A device for hierarchical reception in a mobile multimedia broadcasting system, includes:

a monitoring unit configured to monitor location information of multiplexing subframes of a broadcasting channel frame, code streams of a plurality of layers of a video stream of a video service being encapsulated in said multiplexing subframes;

a receiving unit configured to receive only basic layer code stream of the video stream or both basic layer code and corresponding enhanced layer code stream of the video stream, according to video stream processing capability of a receiving terminal;

a decoding unit configured to decode only the basic layer code stream or both the basic layer code stream and the corresponding enhanced layer code stream; and

an outputting unit configured to output video data of the basic layer code stream or that generated by combining the basic layer code stream with the corresponding enhanced layer code stream.

In the disclosure, the video stream of the video service is hierarchically coded; each hierarchical video stream is respectively encapsulated to different multiplexing subframes of the CMMB broadcasting channel frame; during the transmission of the video stream data, the location information of the multiplexing subframes where each hierarchical video stream is carried in the CMMB broadcasting channel frame is transmitted to a receiving terminal; and the receiving terminal, by monitoring the location information of the multiplexing subframes carrying each hierarchical video stream in the CMMB broadcasting channel frame and the video stream decoding capability supported thereby, determines to only receive the basic layer code stream or both the basic layer code stream and its corresponding enhanced layer code stream, decodes only the received basic layer code stream or both the basic layer code stream and its corresponding enhanced layer code stream and outputs it to a user. In the disclosure, the transmission of hierarchical video stream data does not need an independent channel; each hierarchical video stream data can share the same channel layer or modulation layer, so that the CMMB system can be automatically backward compatible with the receiving terminal which does not support hierarchical is decoding; and the receiving terminal can select to receive only the basic layer data or both the basic layer data and its corresponding enhanced layer data according to its own condition.

### BRIEF DESCRIPTION OF THE DRAWINGS

FIG. 1 is a diagram showing the composition structure of a CMMB channel frame;

FIG. 2 is a flowchart of a method for hierarchical transmission in a mobile multimedia broadcasting system according to the disclosure;

FIG. 3 is a diagram showing the composition structure of a broadcasting channel frame of the disclosure;

FIG. 4 is a flowchart of a method for hierarchical reception in a mobile multimedia broadcasting system according to the disclosure;

FIG. 5 is a diagram showing the composition structure of a hierarchical transmitting device in a mobile multimedia broadcasting system according to the disclosure; and

FIG. 6 is a diagram showing the composition structure of a hierarchical receiving device in a mobile multimedia broadcasting system according to the disclosure.

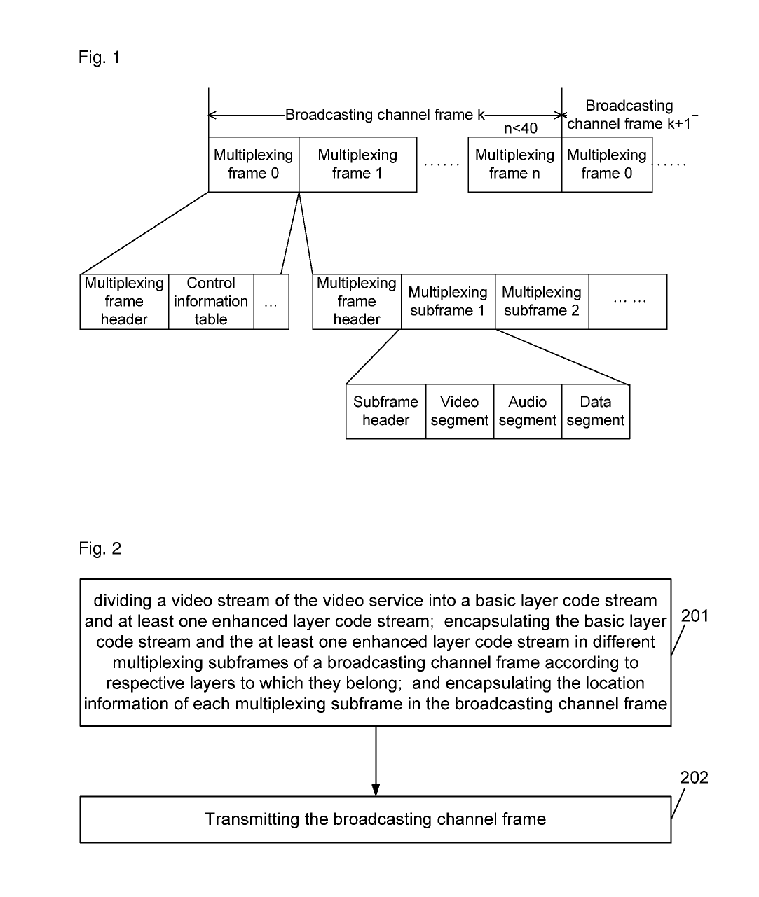

### DETAILED DESCRIPTION

The principle of the disclosure is to code video streams of video services hierarchically. Specifically, a plurality of hierarchical video streams are encapsulated in different multiplexing subframes of a CMMB broadcasting channel frame. During the transmission of video stream data, location information of the multiplexing subframes of the CMMB broadcasting channel frame, in which the hierarchical video streams are carried, is transmitted to a receiving terminal. The receiving terminal monitors the location information of the multiplexing subframes of the CMMB broadcasting channel frame, and then depending on its video stream decoding capabilities, determines to receive only a basic layer code stream or both the basic layer code stream and corresponding enhanced layer code stream. Accordingly, the receiving terminal decodes only the received basic layer code stream or both the received basic layer code stream and corresponding enhanced layer code stream, and outputs to a user. In the disclosure, the transmission of hierarchical video stream data does not need an independent channel; each hierarchical video stream data can share the same channel layer or modulation layer, so that the CMMB system can be automatically backward compatible with the receiving terminal which does not support hierarchical decoding; and the receiving terminal can select to receive basic layer data or the basic layer data and its corresponding enhanced layer data according to its own condition. The solution of the disclosure is simple to implement and is practical.

To make the objective, technical solution and advantages of the disclosure clearer, the disclosure is further described below with reference to embodiments and drawings in detail.

FIG. 2 is a flowchart of a method for hierarchical transmission in a mobile multimedia broadcasting system according to the disclosure. As shown in FIG. 2, the method for hierarchical transmission in the mobile multimedia broadcasting system according to the disclosure includes the following steps 201-202.

Step 201 includes to divide a video stream of a video service into a basic layer code stream and at least one enhanced layer code stream, to encapsulate, in different multiplexing subframes of a broadcasting channel frame, the basic layer code stream and the at least one enhanced layer code stream according to respective layers to which they belong, and to encapsulate location information of each multiplexing subframe in the broadcasting channel frame.

Specifically, the video stream of the video service may be coded based on the abovementioned SVC approach to generate a basic layer code stream and at least one enhanced layer code stream, wherein, in addition to a basic video data stream, the basic layer code stream also includes an audio stream and other basic data information of the video service. The basic layer code stream directs to ordinary receiving terminals. An ordinary receiving terminal can obtain a basic video service with a limited image quality by decoding the basic layer code stream. The enhanced layer code stream directs to optimization of video images of the video service and its implementation needs the decoded data of the basic layer code stream. For a receiving terminal which supports advanced video processing, besides the basic layer code stream data, it also receives corresponding enhanced layer code stream, and respectively decodes the basic layer code stream and its corresponding enhanced layer code stream to acquire an excellent video image, thereby reflecting an optimization in video services.

CMMB system processes the basic layer code stream and the enhanced layer code stream differently depending on layers those layer code streams belong. In particular, the basic layer code stream and the enhanced layer code stream are carried in different multiplexing subframes of the broadcasting channel frame according to different layers to which those layer code streams belong. Preferably, the multiplexing subframes carrying those layer code streams may have an interval of time suitable to ensure reliable reception of the video stream, to enable a CMMB system to support a multicast service. Preferably, the multiplexing subframes of those layer code streams may be placed in different multiplexing frames. Preferably those layer code streams may be pleaced in multiplexing subframes of those multiplexing frames having the same number, to provide a simple description to location information of those layer code streams. Basically, the video stream should not be divided into two much layers. A video stream, normally, may be divided into two or three layers. In other words, a basic layer code stream may be provided with one or two corresponding enhanced layer code streams. In this case, a hierarchical video stream will not take up much of resources of CMMB channel broadcasting frames. The principle of the technical solution of the disclosure will be further described below with a specific embodiment

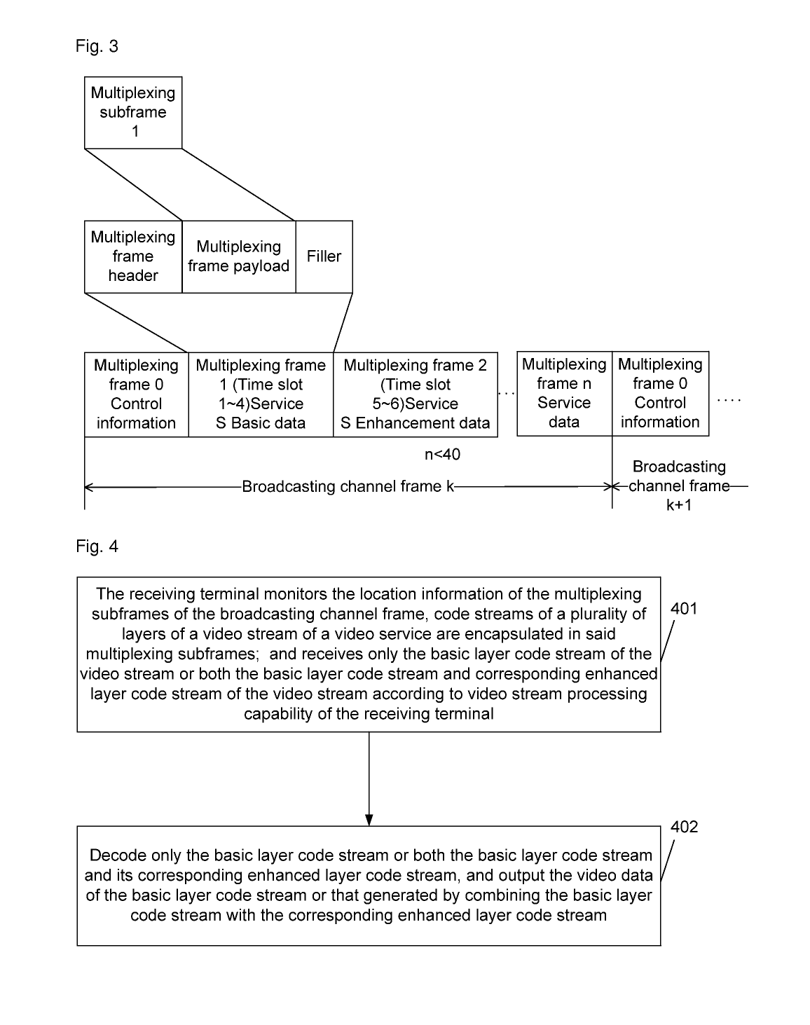

Assuming that a video service S is a television service containing video data and audio data, and the video service S is coded by the approach of SVC to generate one basic layer video code stream and one enhanced layer video code stream. FIG. 3 is a diagram showing the composition structure of a broadcasting channel frame according to the disclosure. As shown in FIG. 3, there are 40 time slots at a frequency point F, with a time slot 0 (i.e., multiplexing frame 0) used to transmit control information and time slots 1-39 used to transmit service information. A multiplexer arranges the video basic layer code stream, audio and other basic data information of the video service S in multiplexing subframe 1 of multiplexing frame 1, with the “multiplexing frame 1” occupying time slots 1-4. The video enhanced layer code stream of the video service S is arranged in multiplexing subframe 1 of multiplexing frame 2, with the multiplexing frame 2 occupying time slots 5-6. Multiplexing frames 1 and 2 would no longer be used to carry other services. Location description information of multiplexing frames carrying those layer code streams (the basic layer code stream and corresponding enhanced layer code streams) is added into the control information and Electronic Service Guide (ESG) information of the service. The description information indicates that, in the video service S, there are two multiplexing subframes, one is multiplexing subframe 1 of multiplexing frame 1 carrying the basic layer code stream data of the service, the other one is multiplexing subframe 1 of multiplexing frame 2 carrying the enhanced layer code stream data.

The multiplexer acquires the basic layer code stream V1 and enhanced layer code stream V2 of the video service S and encapsulates them in corresponding multiplexing subframes 1 of multiplexing frames 1 and 2 respectively. The multiplexer also acquires the audio code stream and other basic data segment information of the video service S and adds them into multiplexing subframe 1 of multiplexing frame 1. In other words, the audio code stream and other basic data segment information of the video service S are carried in the same multiplexing subframe as the basic layer code stream. The location description information of multiplexing frames carrying those layer code streams is carried in multiplexing frame 0 of the broadcasting channel frame and used to indicate, for a receiving terminal, the location of multiplexing frames of those layer code streams; this helps the receiving terminal make it easy to receive the video service S.

Step 202 is to transmit the broadcasting channel frame.

The multiplexer outputs the multiplexing frames carrying those layer code streams, which may form a broadcasting signal through modulation and transmission. A further description is made based on the abovementioned embodiment as follows. The multiplexer outputs the whole multiplexing frames 1 and 2, which may form broadcasting through modulation and transmission.

FIG. 4 is a flowchart of a method for hierarchical reception in a mobile multimedia broadcasting system of the disclosure; as shown in FIG. 4, the hierarchical receiving method in the mobile multimedia broadcasting system of the disclosure includes the following steps:

Step 401: a receiving terminal monitors the location information of the multiplexing subframes of the broadcasting channel frame is located, wherein code streams of a plurality of layers of a video stream of a video service are encapsulated in said multiplexing subframes, and the receiving terminal receives only basic layer code stream of the video stream or both basic layer code and corresponding enhanced layer code stream of the video stream, according to video stream processing capability of the receiving terminal.

The receiving terminal monitors the multiplexing frame 0 in the broadcasting channel frame and receives the control information and the ESG information to correctly receive the multimedia broadcasting service and synchronously monitor the location is information of the multiplexing subframes where the code stream of each layer in the hierarchical video service is located; it further determines whether to only receive the multiplexing subframes where the basic layer code stream is located or to receive the basic layer code stream and its corresponding enhanced layer code streams according to its own processing capability; it should be noted that whether to receive the enhanced layer code streams by the receiving terminal is also determined according to the processing capability; the receiving terminal having a strong processing capability can process all the enhanced layer code streams transmitted by the system, while the receiving terminal having a poor processing capability can only receive the enhanced layer code streams corresponding to its capability, of course, the picture quality of the video services acquired by the receiving terminals is also different; the picture quality of the video services acquired by the receiving terminal having the strong processing capability is relatively good, or, can meet corresponding video service functions, such as, supporting a stereoscopic playing effect. A basic receiving terminal can only receive a basic layer code stream and output a basic video picture.

Step 402: only the basic layer code stream or both the basic layer code stream and its corresponding enhanced layer code stream are decoded, and the video data of the basic layer code stream or that generated by combining the basic layer code stream with the corresponding enhanced layer code stream.

The receiving terminal decodes only the received basic layer code stream or both the basic layer code stream and its corresponding enhanced layer code stream, and outputs the video service corresponding to the basic layer code stream; while the receiving terminal receiving the enhanced layer code stream respectively decodes the received basic layer code stream and its enhanced layer code stream, combines the video stream data in the basic layer code stream with its enhanced layer code stream, and outputs a video service having a better picture quality or supporting corresponding functions (such as a stereoscopic playing function).

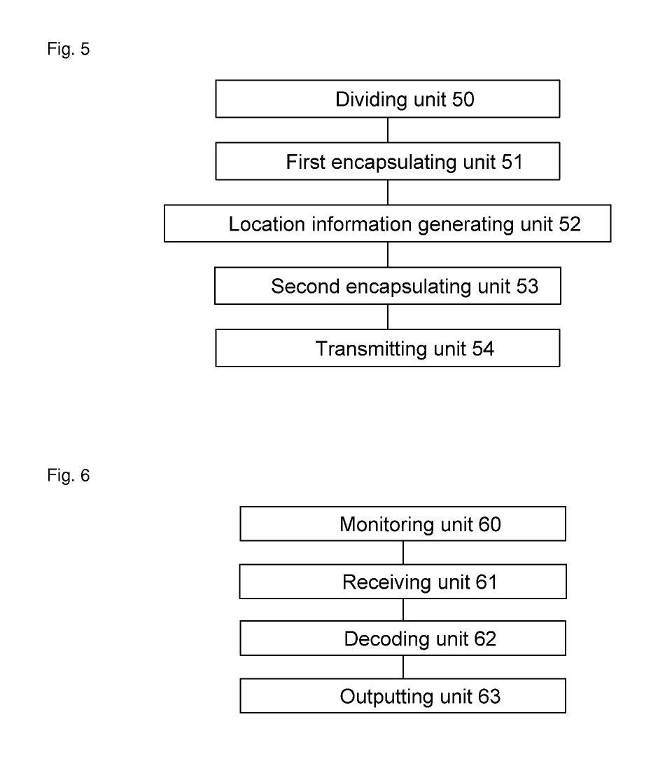

FIG. 5 is a diagram showing the composition structure of a hierarchical transmitting device in a mobile multimedia broadcasting system of the disclosure; as shown in FIG. 5, the hierarchical transmitting device in the mobile multimedia broadcasting system of the disclosure includes a dividing unit 50, a first encapsulating unit 51, a location information generating unit 52, a second encapsulating unit 53 and a transmitting unit 54, wherein the dividing unit 50 is used for sequentially dividing the video stream of the is video service into a basic layer code stream and at least one enhanced layer code stream and can be implemented by an SVC coder. The first encapsulating unit 51 is used for respectively encapsulating the basic layer code stream and at least one enhanced layer code stream in different multiplexing subframes of the broadcasting channel frame according to respective layers to which they belong. The location information generating unit 52 is used for generating location information of said multiplexing subframes. The second encapsulating unit 53 is used for encapsulating the location information of each multiplexing subframe in the broadcasting channel frame. And the transmitting unit 54 is used for sending the broadcasting channel frame to the receiving terminal. The basic layer code stream and the enhanced layer code stream are born in different multiplexing subframes of the broadcasting channel frame according to the different layers they belong to. In order to ensure that the video stream is received reliably, the multiplexing subframes carrying the code stream of each layer preferably have a certain time interval therebetween to make the CMMB system support a multicast service. The multiplexing subframes of the code stream of each layer are preferably located in different multiplexing frames; and, the code stream of each layer is preferably located in the multiplexing subframes having the same number in each multiplexing frame in order to make the location information of the multiplexing subframes described very simply.

The hierarchical transmitting device in the mobile multimedia broadcasting system in FIG. 5 is adapted to the CMMB system.

It should be understood by those skilled in the art that the realization function of each processing unit in the hierarchical transmitting device in the mobile multimedia broadcasting system in FIG. 5 can be understood with reference to the related description in FIG. 2. The function of each unit in the hierarchical transmitting device in the mobile multimedia broadcasting system in FIG. 5 can be realized by the program running on a processor and can also be realized by a specific logic circuit.

FIG. 6 is a diagram showing the composition structure of a hierarchical receiving device in a mobile multimedia broadcasting system of the disclosure, as shown in FIG. 6, the hierarchical receiving device in the mobile multimedia broadcasting system of the disclosure includes a monitoring unit 60, a receiving unit 61, a decoding unit 62 and an outputting unit 63, wherein the monitoring unit 60 is used for monitoring the location information of the multiplexing subframes of the broadcasting channel frame, wherein code streams of a plurality of layers of a video stream of a video service being encapsulated in said multiplexing subframes. The receiving unit 61 is used for receiving only basic layer code stream of the video stream or both basic layer code and corresponding enhanced layer code stream of the video stream, according to video stream processing capability of a receiving terminal. The decoding unit 62 is used for decoding only the basic layer code stream or both the basic layer code stream and the corresponding enhanced layer code stream. And the outputting unit 63 is used for outputting video data of the basic layer code stream or that generated by combining the basic layer code stream with the corresponding enhanced layer code stream.

The hierarchical receiving device in the mobile multimedia broadcasting system in FIG. 6 is adapted to the receiving terminal.

It should be understood by those skilled in the art that the realization function of each processing unit in the hierarchical receiving device in the mobile multimedia broadcasting system in FIG. 6 can be understood with reference to the related description in FIG. 4. The function of each unit in the hierarchical receiving device in the mobile multimedia broadcasting system in FIG. 6 can be realized by the program running on a processor and can also be realized by a specific logic circuit.

To sum up, what described above are only preferred embodiments of the disclosure, and the scope of protection of the disclosure is not limited herein.

1. A method for hierarchical transmission in a mobile multimedia broadcasting system, comprising:
dividing a video stream of a video service into a basic layer code stream and at least one enhanced layer code stream;
encapsulating, in different multiplexing subframes of a broadcasting channel frame, the basic layer code stream and the at least one enhanced layer code stream according to respective layers to which they belong;
encapsulating, in the broadcasting channel frame, location information of said multiplexing subframes; and
transmitting the broadcasting channel frame.

2. The method according to claim 1, wherein said multiplexing subframes have an interval of time with a predetermined threshold.

3. The method according to claim 1, wherein said multiplexing subframes belong to is different multiplexing frames.

4. The method according to claim 3, wherein said multiplexing subframes have a same subframe number.

5. The method according to claim 1, wherein audio stream and other basic data streams of the video service are carried in multiplexing subframes in which the basic layer code stream is encapsulated.

6. A method for hierarchical reception in a mobile multimedia broadcasting system, comprising:
monitoring, by a receiving terminal, location information of multiplexing subframes of a broadcasting channel frame, code streams of a plurality of layers of a video stream of a video service being encapsulated in said multiplexing subframes;
receiving only basic layer code stream of the video stream or both basic layer code and corresponding enhanced layer code stream of the video stream, according to video stream processing capability of the receiving terminal;
decoding only the basic layer code stream or both the basic layer code stream and the corresponding enhanced layer code stream; and
outputting video data of the basic layer code stream or that generated by combining the basic layer code stream with the corresponding enhanced layer code stream.

7. The method according to claim 6, further comprising:
decoding audio stream and other basic data streams of the video service, while decoding the basic layer code stream.

8. A device for hierarchical transmission in a mobile multimedia broadcasting system, comprising:
a dividing unit, configured to divide a video stream of a video service into a basic layer code stream and at least one enhanced layer code stream;
a first encapsulating unit configured to encapsulate, in different multiplexing subframes of a broadcasting channel frame, the basic layer code stream and the at least one enhanced layer code stream according to respective layers to which they belong;
a location information generating unit configured to generate location information of said multiplexing subframes;
a second encapsulating unit configured to encapsulate, in the broadcasting channel frame, the location information of said multiplexing subframes; and
a transmitting unit configured to transmit the broadcasting channel frame to a receiving terminal.

9. The device according to claim 8, wherein said multiplexing subframes have an interval of time with a predetermined threshold.

10. The device according to claim 8, wherein said multiplexing subframes belong to different multiplexing frames.

11. The device according to claim 10, wherein said multiplexing subframes have the same subframe number.

12. A device for hierarchical reception in a mobile multimedia broadcasting system, comprising:
a monitoring unit configured to monitor location information of multiplexing subframes of a broadcasting channel frame, wherein code streams of a plurality of layers of a video stream of a video service being encapsulated in said multiplexing subframes;
a receiving unit configured to receive only basic layer code stream of the video stream or both basic layer code and corresponding enhanced layer code stream of the video stream, according to video stream processing capability of a receiving terminal;
a decoding unit configured to decode only the basic layer code stream or both the basic layer code stream and the corresponding enhanced layer code stream; and
an outputting unit configured to output video data of the basic layer code stream or that generated by combining the basic layer code stream with the corresponding enhanced layer code stream.
